(19) United States
(12) Patent Application Publication
(10) Pub. No.: US 2022/0301360 A1
(43) Pub. Date: Sep. 22, 2022

(54) UNCONNECTED MACHINE DIAGNOSTIC PROCEDURE

(71) Applicant: DEERE & COMPANY, Moline, IL (US)

(72) Inventors: Curtis P. Ritter, Waterloo, IA (US); Murtaza Hita, Pune (IN); Joseph M. Featherstone, Cadar Falls, IA (US); Joseph A. Bell, Marion, IN (US); Marc J. Gunnarson, Hudson, IA (US)

(21) Appl. No.: 17/207,127

(22) Filed: Mar. 19, 2021

(51) Int. Cl. G07C 5/00; G07C 5/08; G08G 1/00

(52) U.S. Cl. CPC G07C 5/008; G07C 5/0808; G08G 1/20

(57) ABSTRACT

The system and method include obtaining fleet operating data from a fleet of machines and a machine operating data set from an individual machine. The fleet operating data includes a plurality of fleet operating data codes and fleet time data. The machine operating data includes at least one machine operating data code. A diagnostic system server is configured to establish a correlation for individual data codes and groups of data codes of the plurality of fleet data codes based and to compile one or more of the individual data codes and one or more of the groups of data codes into a plurality of diagnostic entries in a database. The diagnostic system analyzes the at least one machine operating data code to determine if an alert is associated with the at least one machine data code and provide any associated alerts to a user.

### FIELD

Various exemplary embodiments relate to performing diagnostic tests to diagnose service issues with machines without telematics data.

### BACKGROUND

Modern engines are complex systems that can include numerous mechanical and electrical components. Due to these complex systems, complex monitoring and diagnostic testing are often required to detect and diagnose failures or errors in the engine. Certain engines are equipped with internal diagnostic systems. Internal systems however, may be limited in scope due to size, cost, or performance considerations associated with the engine. Technicians and service centers are often equipped with significantly more robust and sophisticated diagnostic capabilities. The size and remote location use of some machines or vehicles can make it impractical to bring to a service center, and the complexity of the systems can result in a technician that travels to the location of the machine having to spend a significant amount of time diagnosing the system and carry a large number of replacement parts to the location.

Systems and methods of improving the diagnosis and service of the engine (and entire machines) can reduce the amount of time it takes a technician to resolve an issue, as well as improve machine uptime and the customer experience. Due to the complexity of modern engines and the large number of potential underlying causes of a diagnostic issue, a technician must utilize sophisticated too s and follow multiple steps to diagnose a problem.

### SUMMARY

Certain aspects are directed to a method of diagnosing an engine powered machine. Fleet operating data is obtained from a fleet of machines. The fleet operating data includes a plurality of fleet operating data codes and fleet time data. The fleet time data includes an overall operating time and an active time associated with each of the plurality of fleet data codes. A frequency of occurrence is established for individual data codes of the plurality of fleet data codes based on the fleet time data. A frequency of occurrence is established for groups of data codes of the plurality of fleet data codes based on the fleet time data. A determination is made if the individual data codes pass a first frequency threshold. A determination is made if the groups of data codes pass a second frequency threshold. One or more of the individual data codes and one or more of the groups of data codes are compiled into a plurality of diagnostic entries in a database. An alert is associated with at least a portion of the diagnostic entries. A machine operating data set is obtained. from an unconnected machine. The operating data set includes at least one machine operating data code associated with a machine problem. The at least one machine operating data code is referenced with the diagnostic entries to determine if an alert is associated with the at least one machine data code. Any associated alerts are provided to a user.

According to certain aspects, an engine diagnostic system includes a communication transceiver configured to receive fleet operating data from a fleet of machines and to receive a machine operating data set from an individual machine. The fleet operating data includes a plurality of fleet operating data codes and fleet time data.

The fleet time data includes an overall operating time and an active time associated with each of the plurality of fleet data codes. The machine operating data set includes at least one machine operating data code associated with a machine problem. A database is connected to the communication transceiver for storing the fleet operating data. A diagnostic system server is connected to the database and the communication transceiver. The diagnostic system server includes at least one processor configured to establish a frequency of occurrence for individual data codes of the plurality of fleet data codes based on the fleet time data, establish a frequency of occurrence for groups of data codes of the plurality of fleet data codes based on the fleet time data, determine if the individual data codes pass a first frequency threshold, determine if the groups of data codes pass a second frequency threshold, compile one or more of the individual data codes and one or more of the groups of data codes into a plurality of diagnostic entries in the database, analyze the at least one machine operating data code to determine if an alert is associated with the at least one machine data code, and provide any associated alerts to a user.

### BRIEF DESCRIPTION OF THE DRAWINGS

The aspects and features of various exemplary embodiments will be more apparent from the description of those exemplary embodiments taken with reference to the accompanying drawings, in which:

FIG. 1 is a schematic diagram of an exemplary engine electronic system.

FIG. 2 is a schematic diagram of an exemplary diagnostic system

FIG. 3 is a flow chart illustrating an exemplary unconnected machine diagnostic procedure.

FIG. 4 is an example of operating data provided to the diagnostic system.

FIG. 5 is a flow chart illustrating an exemplary diagnostic procedure to create alerts for known issues based on fleet machine data and determine if any alerts are relevant to an unconnected. machine.

### DETAILED DESCRIPTION OF EXEMPLARY EMBODIMENTS

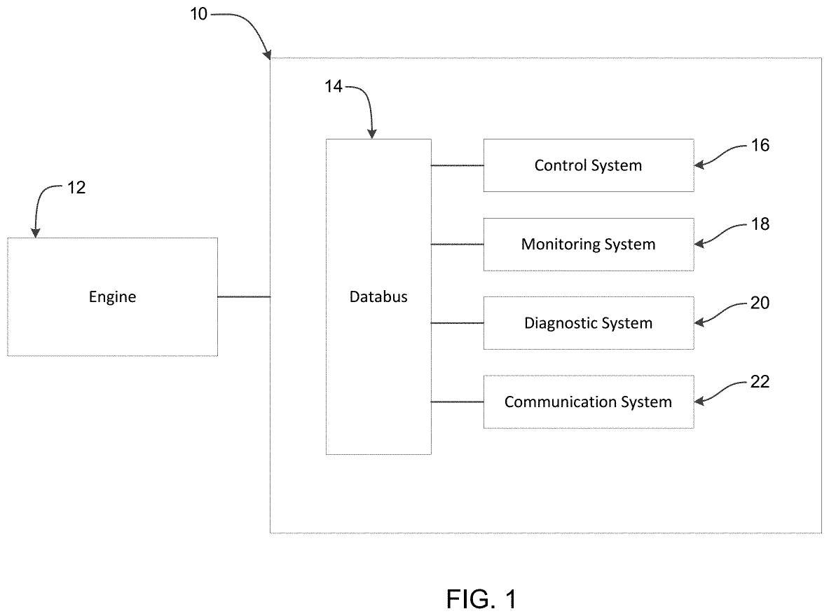

FIG. 1 shows an exemplary embodiment of an electronic processing system 10 that is connected to an engine 12. The engine 12 can be part of a vehicle that contains one or more ground engaging members, for example tires or treads, that are powered by the engine. Alternative embodiments can be directed to other types of moving or stationary machines that utilize an engine, for example a diesel engine used in a generator.

In the exemplary embodiment shown in FIG. 1, the electronic processing system 10 includes a data bus 14 in communication with various components including a control system 16, a monitoring system 18, a diagnostic system 20, and a communication system 22. The electronic system 10 is configured to diagnose or at least partially diagnose different error conditions in the engine 12.

Modern engines require sophisticated tools for diagnostics and service. There are many steps a technician must follow to diagnose an engine problem such as visual inspection, gathering data, or utilizing diagnostic tools. According to an exemplary embodiment, the diagnostic system 20 is connected to or integrated with the electronic system 10 to perform interactive tests and calibrations.

The electronic processing system 10 can include one or more of a data processor and data storage component. The electronic processing system 10 can include a general-purpose computer (e.g. microcontroller) that is programmed with software modules. The data bus 14 provides communication between the different components.

The control system 16 can include one or more controllers or electronic control units, for example an engine control unit. The control system 16 can include software and/or firmware stored in memory to perform different operations and tasks.

The monitoring system 18 can include various inputs from the associated engine system. For example, inputs can provide information from the ignition switch, battery voltage, throttle, and sensors or other measurement devices used to monitor the status of components in the engine 12. The monitoring system can collect voltage information associated with different sensors, and this information can be compared to stored values in a chart or table. Based on discrepancies between the actual and stored values, faults, error codes or diagnostic trouble codes (DTCs) can be generated, either by the control system 16 or the diagnostic system 20.

The diagnostic system 20 can be configured to perform multiple tasks, including initiating tests and recording errors sensed by the monitoring system 18. The diagnostic system 20 can receive and record, for example through a software module or instructions for analyzing, the results of diagnostic tests, fault codes, error messages, status messages, or test results provided by the monitoring system 18. The diagnostic system 20 can also be capable of analyzing or comparing the information provided by the monitoring system 18 to a database that contains prior information related to the engine and standard operating information. The diagnostic system 20 can record and store data associated with the engine, and transfer that data via the communication system 22 to a local output and/or a remote location. A local output can be a screen or other user interface associated with the system 10 or a user access device that is connected to the system, for example through hard wired connection, or through a wireless connection such as Wi-Fi, Bluetooth, or other near field communication, A remote location can include transferring data via the communication system 22 over a network to a dealer or service center.

Locally, the information can be processed by an access device, such as a technician computer. The technician may also be able to access a controlled menu via an onboard computer system. At a remote location, a service center can receive the transmitted data and then process the data to provide a recommendation to a technician. The data can be processed by one or more data processing systems that can include a server, central processing unit, software modules or programmable logic, and electronic memory. In certain instances, the recommendation identifies a reduced number of potential sources of the problem from the maximum potential sources to allow the technician to carry fewer parts or less equipment when visiting a location. The diagnostic system 20 also may be capable of producing, storing, or communicating DTCs.

The electronic processing system can utilize other components including processors, data storage, data ports, user interface systems, controller area network buses, timers, etc., as would be understood by one of ordinary skill in the art.

The communication. system 22 is configured to locally and remotely communicate information over a communication network. The communication system 22 can provide communication over different wired or wireless systems and networks including mobile, satellite, Wi-Fi, near-field, Bluetooth, or a combination thereof as needed. In an exemplary embodiment, the communication system 22 is a telematics system. The telematics system includes, for example, a network of regional, national, or global hardware and software components. In addition, the telematics service may be provided by a private enterprise, such as an independent third-party company that provides the service to other companies, a manufacturing company that provides the service to its customers, or a company that provides the service to its own fleet of vehicles. Alternatively, the telematics service may be provided by a governmental agency as a public service. JDLink™ is an example of a telematics service, which is available from John Deere Company.

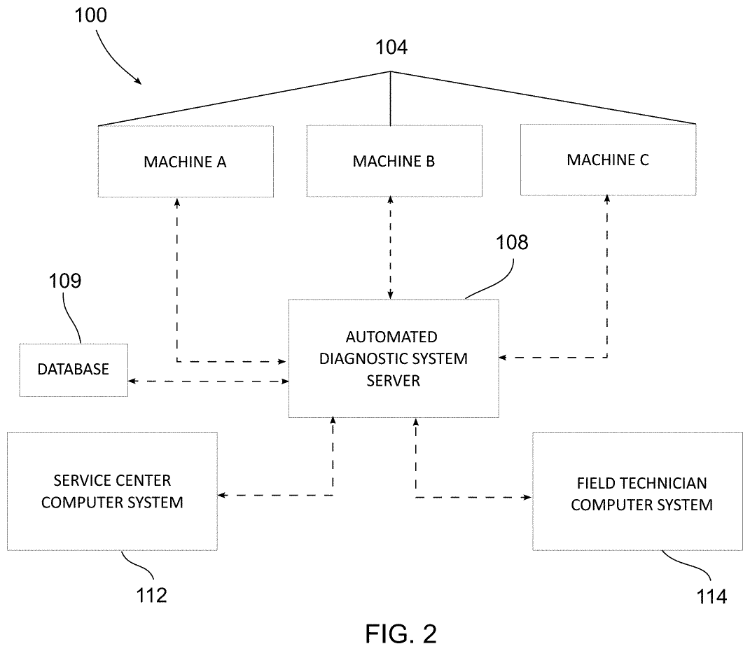

FIG. 2 illustrates an exemplary machine diagnostic system 100. A plurality of machines 104 communicate with an automated diagnostic system server 108, which can also communicate with at least one service center computer system 112 and a field technician computer system 114. The machine diagnostics system 100 monitors information obtained from various sources regarding each of the machines 104. For example, the machine diagnostics system 100 may obtain information directly from the machines 104, from a manufacturer associated. with the machines 104, and/or from the service center computer system 112 or field technician computer system 114.

The machine diagnostics system 100 uses the gathered information about the machines 104 to optimize the operation, maintenance, and repair of the machines 104. For example, the automated. diagnostic system server 108 can use obtained information to build a diagnostic database 109. The diagnostic database 109 can be local or remote, and can store diagnostic information relevant to different machines. In another example, the machine diagnostics system 100 can also allow the automated diagnostic system server 108 to monitor information about the machines 104 and alert the service center computer system 112 when a service issue associated. with one of the machines 104 is detected b the automated diagnostic system server 108. The service center computer system 112 may notify a technician about the issue and then proactively schedule or initiate preventative maintenance on the machine 104 before the machine 104 encounters a more serious service issue.

The machines 104 can be different types of machines, each being configured to perform a specific task (e.g., digging, harvesting, mowing, spraying, etc.). For example, the machines 104 may include vehicles such as shovels, tractors, box drills, planters, harvesters, scrapers, sprayers, cutters, shredders, bailers, etc. The machines 104can also or alternatively include other equipment that is not considered a vehicle.

In some implementations, the service center computer system 112 includes a network of computers located throughout the service center and a local database for storing information related to the services provided to each machine 104. The service center computer system 112 communicates with the automated. diagnostic system server 108 through an Internet connection (or another public or private, wired or wireless data communication network).

When technicians perform services on a machine 104, the technicians can record, on one of the networked computers, specific information about the service provided to the machine 104 through the field technician computer system 114 or through the machine 104 itself. The technicians may record date of service, service issue resolved, manner in which the service issue was resolved, whether the service needs to be performed periodically as is the case with maintenance service, parts used to resolve the service issue, time necessary to resolve the service issue, steps taken before service issue was resolved (e.g., if other parts or components were checked before determining the root cause of a service issue), etc. In this context, this type of information regarding the service provided to the machine 104 is referred to as field service data. Accordingly, when referring to field service data, reference is made to some or all of the information listed above as well as other information relevant to the service issue, the service provided, and the service result. The database may also include identifying information for the machine 104 such as the type of machine, any serial and/or model numbers associated with the machine 104, a user associated with the machine 104 (e.g., an owner or manager, and contact information for the user.

The service center computer system 112 provides field service data to the automated diagnostic system server 108 through the Internet connection. The field service data, once provided to the automated diagnostic system server 108, can be incorporated into new procedures for addressing a particular service issue for a machine 104 more efficiently.

The service center computer system 112 receives notifications regarding the state and/or operation of the machines 104 through the automated diagnostic system server 108 (e.g., notifications of a service issue associated with a machine 104). The service center computer system 112 also receives instructions or guidance for addressing particular service issues from the automated diagnostic system server 108. For example, the automated diagnostic system server 108 may provide instructions for a specific machine 104 that take into consideration the specific build and lay-out of the machine 104. Therefore, the exchange of information between the service center computer system 112 and the automated diagnostic system server 108 improves the information received and provided by both systems. On one hand, the service center computer system 112 provides field service data to the automated diagnostic system server 108, which improves the procedures developed by the automated diagnostic system server 108. On the other hand, the automated diagnostic system. server 108 provides improved and focused procedures to the service center computer system 112, which increases the productivity and shortens the time needed to repair and/or conduct maintenance work on the machine 104.

During operation, the service center computer system 112 receives an. indication of a service issue encountered by a machine 104, the service center can then. respond to the service issue, for example by remotely connecting with a machine to provide a software update or by sending a technician to perform the desired or necessary service. In some embodiments, the service center computer system 112 receives an indication of desired and/or necessary service at one of the machines 104 from the automated diagnostic system server 108. In such embodiments, the indication. for desired and/or necessary service may be automatically generated by the automated diagnostic system server 108 and nay be received by the service center computer system 112 at approximately the same time that the automated diagnostic system server 108 transmits the indication for desired and/or necessary service to a user (e.g., owner or responsible party) associated with the machine 104.

Once the diagnostic system server 108 receives information relevant to a machine 104, the diagnostic system server 108 stores the received information, for example on a non-transient computer-readable memory. The diagnostic system server 108 executes instructions stored on the non-transient computer-readable memory that cause the diagnostic system server 108 (or a local technician service device, as discussed in further detail below) to access the machine-specific information stored on the memory and to develop an optimized list of steps for procedures to be performed by a technician using the service center computer system 112 to resolve a particular service issue. In particular, the diagnostic system server 108 is configured to access memory and identify, based on the stored data, a list of conditions relevant to the machine 104 or conditions that will be relevant during a time of service. Based on the list of conditions relevant to the machine 104, the diagnostic system server 108 generates an ordered and optimized list of diagnostic procedures to be performed to address the identified service issue of the machine 104 in an efficient manner. The ordered list takes into consideration the conditions identified as being relevant to the machine 104, the user information, the build data, the machine information, the location information, and the sensor information. In some embodiments, the diagnostic system server 108 gives each of these pieces of information different weights in view of the conditions that are determined to be relevant to the machine 104. A further explanation of an exemplary diagnostic procedure is described in U.S. Pat. No. 10,657,450, the disclosure of which is hereby incorporated by reference in its entirety.

A technician can use the ordered list of diagnostic procedures to repair or provide maintenance for the machine 104 in an efficient manner. Furthermore, as the technician collects further data and performs various procedures on the machine 104, the ordered list of diagnostic procedures is further modified and adapted based on newly acquired information during the service visit, case-based reasoning techniques, and other rules applicable to the machine, the manufacturer, or the service center. An example of such a diagnostic procedure is described in U.S. Pat. No. 9,765,690, the disclosure of which is hereby incorporated by reference in its entirety.

The field technician computer system 114 can be a portable electronic device that includes one or more diagnostic tools. The field technician computer system 114 can be connected directly to a vehicle through a data link and can retrieve information from the vehicles electronic processing system 10. For example, the field technician computer system 114 can receive historical data from the machine as well as current or real-time data from a running machine. The field technician computer system 114 can include a graphical user interface for the user that allows them to view information related to the machine and the service issue with the machine. The field technician computer system 114 can also include a communication unit configured to communicate with the automated diagnostic system server 108. In the illustrated example, the communication unit includes an internet communication unit such that the field technician computer system 114 communicates with the automated diagnostic system server 108 using an Internet protocol. The field technician computer system 114 can also include other components such as, for example, a speaker, a microprocessor, a removable and/or rechargeable power source, communication ports to communicate with other external devices, etc. Furthermore, each field technician computer system 114 includes a non-transitory computer-readable memory.

The field technician computer system 114 can be configured to receive and store various data from the automated diagnostic system server 108 prior to a service visit. This stored data can then be used by the diagnostic tool to provide and adjust the step-by-step procedures to be performed during the service visit based on the outcome of various procedures performed by the technician on the machine during the service visit. In some embodiments, this stored information on the diagnostic tool is used particularly when the technician anticipated that be will not have a reliable Internet connection to communicate with the automated diagnostic system server 108 during the service visit (e.g., during visits to remote or rural job sites).

In certain situations, the machine may be unable to provide telematic information to the diagnostic system server 108. For example, some machines may not be equipped for telematics or subscriptions may be expired. This creates a problem in some diagnostic procedures because there is a lack of historical data on the machine to provide a proper analysis. In such circumstances, a field technician can run a separate diagnostic procedure to more efficiently diagnosis a problem with a machine. The unconnected diagnostic procedure can include any combination of gathering historical data at the machine, gathering real-time data at the machine, and gathering historical data from related machines. This information can be combined to create a solution to the service problem and/or an ordered list of steps to take to diagnose the service problem.

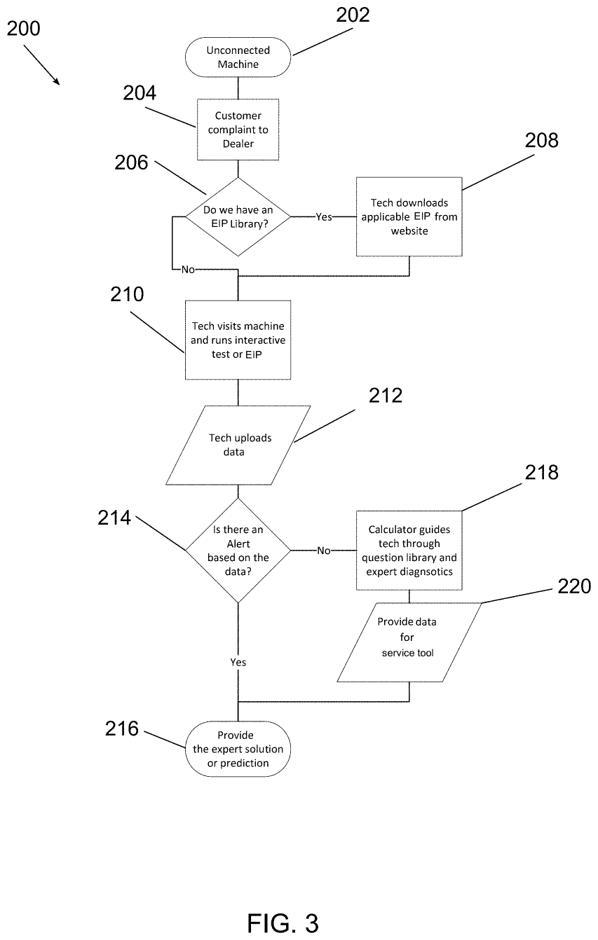

FIG. 3 shows an exemplary diagnostic procedure 200 for an unconnected machine 202. In an exemplary embodiment, the diagnostic procedure can be performed. by the automated diagnostic system server 108, the service center computer system, 112, or another automated system. Initially, a customer can submit a complaint to a dealer 204 related to a service issue for an unconnected machine 202. An engineering instruction package (EIP) check 206 is performed to determine if an existing EIP is available for the machine 202 relevant to the service issue. The EIP can include a preexisting set of instructions that are capable of diagnosing or solving a likely issue with the machine. These instructions can include tests to run, software to update, mechanical issues to check/fix, or other instructions. If an EIP exists, the technician can download the applicable EIP 208 prior to visiting the machine.

Next, the technician can visit the machine and perform the EIP (if available) and/or run an interactive test 210 at the machine. The technician can interface with the machine using the field technician computer system 114. A data link can be opened between the field technician computer system 114 and the vehicle electronic system to, for example through hard wired connection, or through a wireless connection such as Wi-Fi, Bluetooth, or other near field communication. The interactive test can include downloading available historical data from the machine. The historical data can include DTCs stored on the machine, as well as any other stored operational data. While DTCs are described and used herein, it is understood that the system can use any type of operational data or operational codes, which includes any error codes, non-error operating codes, DTCs, and other information. The interactive test can also cause one or more engine components to operate under varied conditions and monitor and record the output of one or more sensors. The conditions can include normal operating conditions for the engine as well as non-normal operating conditions. Non-normal operating conditions can be any operating condition that would not occur during everyday use of the machine. This can include operating a higher or lower speeds than would occur in normal operation, closing or opening valves that would not be closed or open during normal operation, and adjusting fluid pressure values that would not occur during normal operation.

The retrieved information can be uploaded by the technician to the automated diagnostic system server 108 for analysis 212. The information can be uploaded with the technician at the machine, for example through a wireless or cellular connection. If no connection is available, the technician can wait until reaching a connection location or can return to the dealer or other service location.

After receiving the uploaded data, the automated diagnostic system server 108 can determine if there are existing alerts based on the data 214. Existing alerts can include a solution for a known issue. If there are existing alerts, the solution is provided to the technician 216. If no alerts exist, the system guides the tech through a question library and expert diagnostic 218. The question library presents questions to the technician based on any combination of the machine, the service issue, and the obtained data (historical and real-time). The order of questions can be modified based on the technician's answers. As the technician answers questions, the information is provided to a program 220. The service program 220 guides the technician and provides an expert solution 216 to the service issue. An example of such a service program is the John Deere Service ADVISOR™.

After service is complete, the technician can upload the results along with any additional relevant information into the system. All information can be stored in the system to help identify new issues or make the diagnosis more efficient.

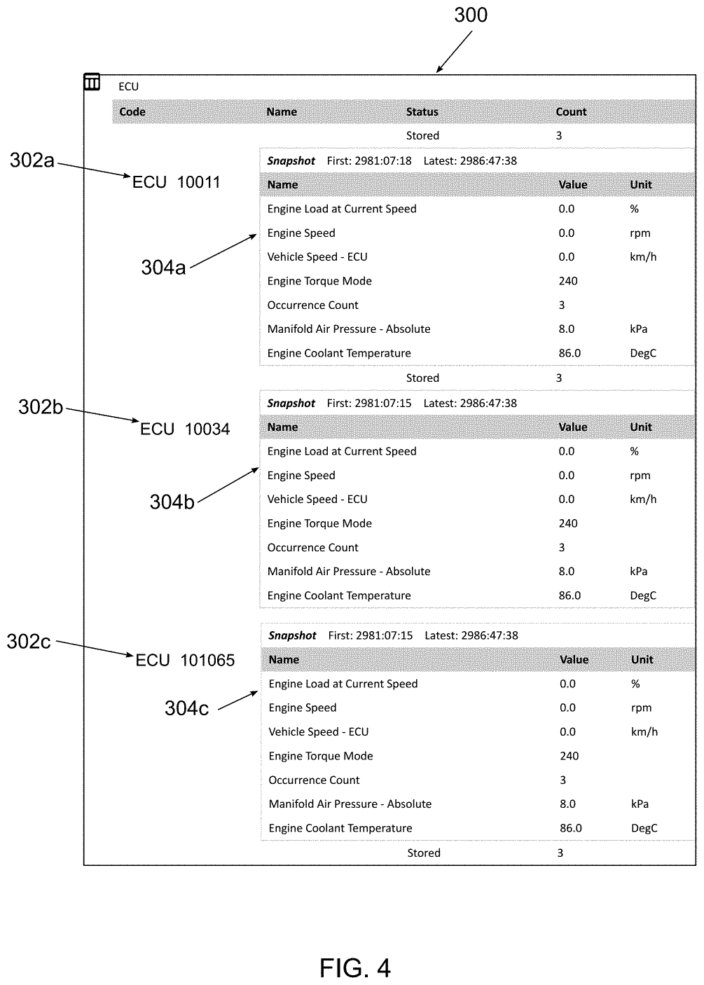

FIG. 4 shows an example of an operating data report that can be extracted by the field technician when running an interactive test shown in step 210 in FIG. 3. The technician visits the machine and opens a data link between the field technician computer system 114 and the vehicle electronic system 10. The interactive test involves obtaining historical data that is stored in the machine. In some embodiments, the machine can store data in memory until it is accessed or cleared by a user or technician. The interactive test can also cause one or more engine components to operate under varied conditions and monitor and record the output of one or more sensors. After the test is complete, vehicle electronic system 10 provides an operating data set 300, for example as shown in FIG. 4, to the field technician computer system 114.

The operating data set can include operating data (e.g., DTCs) from one or more different machine systems of components. The operating data set in FIG. 4shows operating data from an engine control unit (ECU). Operating data also may be provided from different control units (e.g., Central Control Unit, Primary Display Unit, etc.) or other machine systems.

The operating data set 300 can include one or more operating data codes 302, with three distinct codes 302a, 302b, 302c shown in FIG.4. Any number of data codes 302 can be provided depending on the issue or issues present at the machine. These data codes 302 can be industry standard codes or codes specific to a specific company. Each data code 302 includes a snapshot 304 of information about the engine parameters when the operating code was triggered. For example, the snap shots 304 can show the time of first and last occurrence, the relevant engine data, and the number of occurrences.

The operating data set 300 is provided to the field technician who uploads the data as shown in step 212 in FIG. 3. The data can be uploaded. to the automated diagnostic system server 108 to determine if there are existing alerts based on the data set 300. The automated diagnostic system 108 can compare the data codes 302 alone and in any combination, to determine if there are existing alerts associated with the particular machine. For example, the automated diagnostic system 108 can check if there are any existing alerts associated with the individual data codes 302a, 302b, or 302c and if there is an alert associated with any combination of data codes 302a, 302b, 302c.

If any existing alerts are found by the automated diagnostic system 108 that correspond to the data codes 302a, 302b, 302c, all existing alert can be presented to the field technician. For example, a first alert can be associated with data code 302a, a second alert can be associated with the combination of data codes 302a, 302c, and a third alert can be associated with the combination of data codes 302a, 302b, and 302c. All three alerts are presented to the field technicians to assist with either further diagnosing an issue or solving the issue.

The alerts can be presented to the technician in a specific order based on ranking of the likelihood of success. This ranking can be compiled by the automated diagnostic system 108 based on historical data of similar machines. For example, the automated diagnostic system 108 can recognize that when a certain three alerts are present in a machine, a successful diagnosis is more often achieved by following the steps in the second alert, followed by the third alert. The second alert can then be presented as a first option to the field technician, followed by the third alert, with the first alert coming last if needed. While three data codes 302a, 302b, 302c from an ECU are used as an example, it is noted that typical data sets 300 can often exceed 20 data codes, which quickly outpaces the ability of a human technician to perform this calculation and analysis using only the human mind.

In some embodiments, a customer can contact a dealer about a machine problem based on a data code. A technician can enter the data code into the service center computer system 112 or a field technician computer system 114 to determine if there is an alert associated with the data code. The alert can be based on the model of the machine and the historical data of the machine that is stored in the system. If an alert is found, an EIP or other guidance can be provided. In some embodiments, the system can use warranty data, technical support cases info, product recall information, service record information, and software updates along with the data code information to determine relevant alerts.

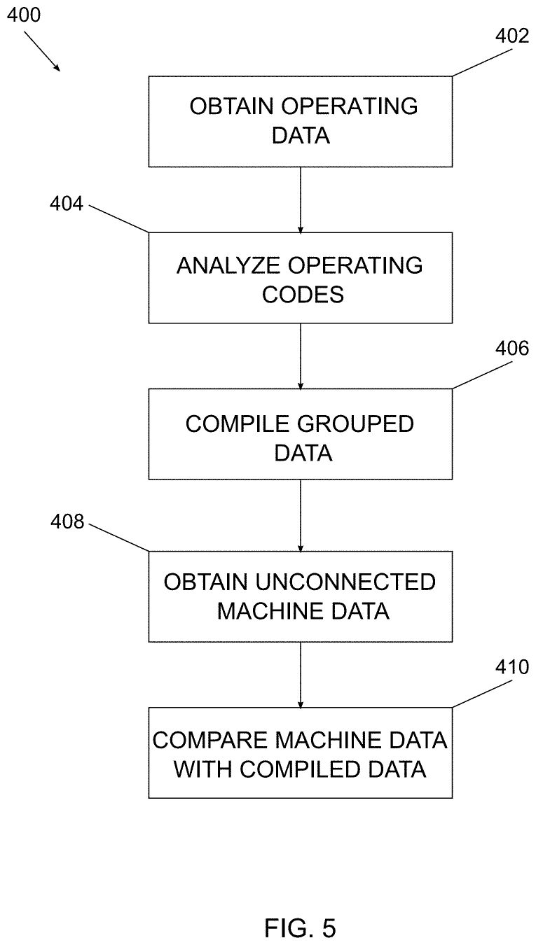

FIG. 5 shows an example of an operating data analysis process 400 that can be used to build a library of alerts and determine if there is an alert for a specific operating data set or operating data code as shown in step 214 in FIG. 3. The operating data analysis process 400 can be performed by the diagnostic system server 108.

Initial operating data is obtained 402 from one or more machines by, for example, the diagnostic system server 108. The data can be identified with, and grouped by, machine, engine type, size, and/or other parameters. The machine operating data can be obtained in any manner, for example through any combination of service centers, telematics, or historical technician data. The machine operating data will contain operating codes (e.g., DTCs) as well as associated operating data (time, relevant engine data) as discussed above with respect to the operating data set 300. The machine operating data can be obtained and updated on a continual basis.

As the data is received, the operating data codes are analyzed 404. Analyzing data codes can identify frequently occurring individual codes or groups of codes to analyze machine problems associated with those codes. For example, if the appearance of a first operating code passes a frequency threshold in the combined data set, it can be identified for analysis and a solution assignment. If the appearance of a second operating code and a third operating code passes a frequency threshold in the combined data set, the second operating code and the third operating code can be grouped together and identified for analysis and a solution assignment. Groups can be two or more associated operating codes.

In certain embodiments, operating codes can be placed into groups of two, and then these groups can be further combined into group chains of associated operating codes. The group chains can contain at least two groups of data codes with each group comprised of at least two different data codes. Identifying groups and longer chains helps to filter data for the technician and provide a more efficient diagnosis. For example, where a technician would previously need to analyze four, six, eight, or more separate codes, groups and chains can provide a single diagnosis for a complex problem.

The operating code analysis 404 can also filter codes for random occurrences, unrelated occurrences, or irrelevant codes. For example, operating code occurrences or groups of occurrences that do not reach a frequency threshold can be disregarded. Certain codes can also be disregarded if they relate to a known issue, but are identified as a problem that does not need to be immediately fixed. The frequency threshold for a single operating code, for a group of operating codes, and for filtering can all be set at the same value or at different values.

Determining the frequency of an occurrence can be based on a comparison of the amount of time an operating code is present in the combined data versus the total operating time of the combined data. For example, the total operating time can be based on a combination of the total operating time (e.g., total operating hours or total operating days) of available data for all machines. The frequency of an operating code occurrence can be based on the total time (hours/days) the code or combination of codes was active on all machines. The total time the operating code or codes were active can be divided by the total operating time to determine a value that represents the frequency. If this value is above or below one or more thresholds, the respective operating codes or operating code groups can be assigned for further analysis, solution assignment, or filtered out as discussed above.

After the data is analyzed, the data can be compiled into a database 406. The compiled data can be associated. with an alert tied to a specific machine problem represented by the operating code or groups of codes. The alert can include information related to solving a problem associated with a given machine. For example, the alert can contain part replacement information, software download information (including hyperlinks), further testing steps, or other maintenance procedures. This information can be continuously or periodically updated.

The system is configured to obtain unconnected machine data 408 from a user such as a technician as shown in step 212 in FIG. 3. The information can include one or more operating data sets 300. After the data is obtained, the unconnected machine data is compared to the compiled data 410 and any associated alerts are provided as shown in step 216 of FIG. 3.

In an example, a machine can output a series of ten operating codes as Code 1-Code 10. The data comparison 410 can determine based on. these ten codes that Code 1 represents a first issue, the chain of Codes 2, 3, 5, 6, 8,10 represents a second issue, Code 9 represents a third issue, and Codes 4 and 7 do not need to be addressed. Known solutions to these issues can be presented to a technician, as well as an indication that certain problems do not need to be addressed. One advantage is that the system can replace (in this example) what was typically ten problems with just three problems. The technician will not have to waste time with unnecessary diagnostic procedures or replacing parts that are properly working. This improves the efficiency of the diagnosis and eliminates extra costs, service time, and unnecessary part replacement associated with typical repairs and diagnostic procedures.

In certain aspects, the system can provide a predictive maintenance function based on the information received from the machine and sent to the technician. The service tool can determine, based on the data codes, that a failure in the machine is likely to occur in a certain time frame and instruct the technician to perform maintenance steps to correct the issue.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated. with manufacturing, assembly, and use of the described embodiments.

What is claimed:

1. A method of diagnosing an engine powered machine comprising:
obtaining fleet operating data from a fleet of machines, the fleet operating data including a plurality of fleet operating data codes and fleet time data, the fleet time data including an overall operating time and an active time associated with each of the plurality of fleet data codes;
establishing a frequency of occurrence for individual data codes of the plurality of fleet data codes based on the fleet time data;
establishing a frequency of occurrence for groups of data codes of the plurality of fleet data codes based on the fleet time data;
determining if the individual data codes pass a first frequency threshold;
determining if the groups of data codes pass a second frequency threshold;
compiling one or more of the individual data codes and one or more of the groups of data codes into a plurality of diagnostic entries in a database;
associating an alert with at least a portion of the diagnostic entries;
obtaining a machine operating data set from an unconnected machine, the operating data set including at least one machine operating data code associated with a machine problem;
referencing the at least one machine operating data code with the diagnostic entries to determine if an alert is associated with the at least one machine data code; and
providing any associated alerts to a user.

2. The method of claim 1, wherein the first frequency threshold is different from the second frequency threshold.

3. The method of claim 1, further comprising filtering out individual data codes that do not pass a third frequency threshold from the diagnostic entries and filtering out groups of data codes that do not pass a fourth frequency threshold from the diagnostic entries.

4. The method of claim 3, wherein the third frequency threshold is different from the fourth frequency threshold.

5. The method of claim 1, wherein the machine operating data set includes at least one machine group of data codes, and further comprising referencing the at least one machine group of data codes with the diagnostic entries to determine if an alert is associated with the at least one group of data codes.

6. The method of claim 1, wherein the machine operating data set is obtained through a field technician computer system.

7. The method of claim 1, wherein the machine operating data set includes historical data stored on the machine.

8. The method of claim 1, wherein the machine operating data set includes data from a test condition instigated by a field technician computer system.

9. The method of claim 1, further comprising combining groups of data codes to create a group chain, wherein the group chain includes at least two groups of data codes with each group comprised of at least two different data codes.

10. The method of claim 1, wherein the machine operating data set includes an occurrence time associated with the machine operating code and engine data associated with the machine operating code.

11. A machine diagnostics system comprising:
a communication transceiver configured to receive fleet operating data from a fleet of machines and to receive a machine operating data set from an individual machine, the fleet operating data including a plurality of fleet operating data codes and fleet time data, the fleet time data including an overall operating time and an active time associated with each of the plurality of fleet data codes, the machine operating data set including at least one machine operating data code associated with a machine problem;
a database connected to the communication transceiver for storing the fleet operating data;
a diagnostic system server connected to the database and the communication transceiver, the diagnostic system server including at least one processor configured to,
establish a frequency of occurrence for individual data codes of the plurality of fleet data codes based on the fleet time data,
establish a frequency of occurrence for groups of data codes of the plurality of fleet data codes based on the fleet time data,
determine if the individual data codes pass a first frequency threshold,
determine if the groups of data codes pass a second frequency threshold,
compile one or more of the individual data codes and one or more of the groups of data codes into a plurality of diagnostic entries in the database,
analyze the at least one machine operating data code to determine if an alert is associated with the at least one machine data code, and
provide any associated alerts to a user.

12. The system of claim 11, further comprising a field technician computer system in communication with the communication transceiver for submitting the machine operating data set to the diagnostic system server.

13. The system of claim 12, wherein the field technician computer system is configured to connect to an engine controller to receive the machine operating data set.

14. The system of claim 11, wherein the first frequency threshold is different from the second frequency threshold.

15. The system of claim 11, wherein the diagnostic system server is further configured to filter out individual data codes that do not pass a third frequency threshold from the diagnostic entries and filter out groups of data codes that do not pass a fourth frequency threshold from the diagnostic entries.

16. The system of claim 11, wherein the machine operating data set includes at least one machine group of data codes, and the diagnostic system server is further configured to compare the at least one machine group of data codes with the diagnostic entries to determine if an alert is associated with the at least one group of data codes.

17. The system of claim 11, wherein the machine operating data set includes historical data stored on the machine.

18. The system of claim 11, wherein the machine operating data set includes data from test condition instigated by a field technician computer system.

19. The system of claim 11, wherein the diagnostic system server is configured to combine groups of data codes to create a group chain, wherein the group chain includes at least two groups of data codes with each group comprised of at least two different data codes.

20. The system of claim 11, wherein the machine operating data set includes an occurrence time associated with the machine operating code and engine data associated with the machine operating code.
